(19) United States
(12) Patent Application Publication
(10) Pub. No.: US 2025/0370147 A1
(43) Pub. Date: Dec. 4, 2025

(54) DETECTOR, IMAGING METHOD AND STORAGE MEDIUM

(71) Applicant: Shanghai United Imaging Healthcare Co., Ltd., Shanghai (CN)

(72) Inventors: Cheng Ni, Shanghai (CN); Can Liao, Shanghai (CN); Wei Zhang, Shanghai (CN); Jingjie Zhou, Shanghai (CN); Hongcheng Yang, Shanghai (CN); Xiaohua Zhu, Shanghai (CN); Li Wang, Shanghai (CN)

(21) Appl. No.: 19/223,064

(22) Filed: May 30, 2025

(30) Foreign Application Priority Data
May 30, 2024 (CN) 202410694969.7

(51) Int. Cl. G01T 1/24; H04N 25/30; H04N 25/78; H04N 25/79

(52) U.S. Cl. CPC G01T 1/247; H04N 25/30; H04N 25/78; H04N 25/79

(57) ABSTRACT

The present application relates to a detector, an imaging method, and a storage medium. The detector includes a plurality of detection regions and a plurality of signal readout circuits. Each of the detection regions includes a plurality of detection sub-regions. The plurality of signal readout circuits are in one-to-one correspondence with the detection regions respectively, each of the signal readout circuits includes a plurality of signal readout sub-circuits, and the plurality of signal readout sub-circuits are in one-to-one correspondence with the plurality of detection sub-regions respectively.

### CROSS REFERENCE TO RELATED APPLICATIONS

This application claims all benefits accruing under 35 U.S.C. § 119 to Chinese Patent Application No. 202410694969.7 filed on May 30, 2024 in the China National Intellectual Property Administration, the content of which is hereby incorporated by reference.

### TECHNICAL FIELD

The present application relates to the field of medical technologies, and in particular, to a detector, an imaging method, and a storage medium.

### BACKGROUND

A detector is an important component in a scanning device. For example, the scanning device is an electronic computed tomography (CT) device, and when the CT device is used to scan a target object, X-rays penetrate through the target object to reach the detector, so that the detector generates a signal based on the X-rays and outputs the signal to a signal readout circuit of the detector, and the signal readout circuit obtains CT scanning data based on the signal, thereby generating a three-dimensional CT image according to the CT scanning data.

### SUMMARY

The present application provides a detector, an imaging method, and a storage medium.

In a first aspect, the present application provides a detector, including:
a plurality of detection regions, each of the detection regions including a plurality of detection sub-regions; and
a plurality of signal readout circuits, the plurality of signal readout circuits being in one-to-one correspondence with the corresponding detection regions respectively, each of the signal readout circuits including a plurality of signal readout sub-circuits, and the plurality of signal readout sub-circuits being in one-to-one correspondence with the plurality of detection sub-regions respectively.

In an embodiment, at least two detection regions have different pixel attribute parameters.

In an embodiment, the pixel attribute parameters include at least one of a type, resolution, collection speed, and material of the detector.

In an embodiment, the pixel attribute parameters of a preset region in the detection region of the detector are higher than those of other regions in the detection region of the detector.

In an embodiment, the preset region is a central part of the detector.

In an embodiment, at least two signal readout circuits have different attribute parameters.

In an embodiment, the attribute parameter of the signal readout circuit includes at least one of an element type and material of the signal readout circuit.

In an embodiment, the detection region is parallel to a corresponding tomographic reconstruction plane of a scanning device.

In an embodiment, the plurality of signal readout circuits are arranged on a plurality of circuit layers of the same circuit board respectively.

In an embodiment, the plurality of circuit layers are controlled independently of each other.

In an embodiment, the signal readout circuit includes: a gate switch control circuit, the gate switch control circuit being configured to turn on a target pixel in the detection region by outputting a gating signal corresponding to the target pixel.

In an embodiment, the signal readout sub-circuit is configured to acquire an output signal of the detection sub-region corresponding to the target pixel under the condition that the target pixel is turned on.

In an embodiment, the detection sub-region is a region obtained by dividing a plurality of pixels in the detection region according to a preset dividing manner, and the preset dividing manner includes a pixel row dividing manner, a pixel column dividing manner, or a pixel block dividing manner.

In an embodiment, each of the signal readout sub-circuits includes an amplifying circuit and a signal conversion circuit;
the amplifying circuit is configured to amplify a first signal of the target pixel and send the first signal to the signal conversion circuit; and
the signal conversion circuit is configured to obtain an output signal corresponding to the target pixel according to the first signal.

In an embodiment, each of the plurality of detection regions is a region formed by partial of pixels of the detector in a row direction and/or a column direction.

In a second aspect, the present application further provides an imaging method, including:
acquiring output signals corresponding to a plurality of signal readout circuits in a detector; and
generating image data from the output signals corresponding to the plurality of signal readout circuits;
wherein the plurality of signal readout circuits are in one-to-one correspondence with a plurality of detection regions in the detector respectively; each of the detection regions includes a plurality of detection sub-regions; and each of the signal readout circuits includes a plurality of signal readout sub-circuits, and the plurality of signal readout sub-circuits are in one-to-one correspondence with the plurality of detection sub-regions respectively.

In an embodiment, the method further includes:
analyzing at least two output signals in the output signals corresponding to the plurality of signal readout circuits to obtain an analysis result; a time difference value between acquisition times of any two output signals in the at least two output signals being smaller than a preset difference value.

In an embodiment, generating the image data from the output signals corresponding to the plurality of signal readout circuits includes:
generating the image data according to the output signals and gating signals corresponding to the plurality of signal readout circuits;
wherein the gating signal and the output signal of the same pixel have a matching relationship.

In an embodiment, the preset difference value is a value close to 0.

In a third aspect, the present application further provides a non-transitory computer-readable storage medium having a computer program stored thereon, the computer program, when executed by a processor, implementing the steps of any one of the above methods.

### BRIEF DESCRIPTION OF THE DRAWINGS

In order to illustrate the technical solutions in the embodiments of the present application or the related art more clearly, the drawings required for describing the embodiments or the related art will be described briefly. Apparently, the following described drawings are merely for some embodiments of the present application, and other drawings can be derived from these drawings by those of ordinary skill in the art without any creative effort.

FIG. 1 is a first schematic structural diagram of a detector according to an embodiment of the present application;

FIG. 2 is a schematic structural diagram of a signal readout circuit in the embodiment of the present application;

FIG. 3 is a schematic structural diagram of a signal readout sub-circuit in the embodiment of the present application;

FIG. 4 is a second schematic structural diagram of the detector according to the embodiment of the present application;

FIG. 5 is a third schematic structural diagram of the detector according to the embodiment of the present application;

FIG. 6 is a fourth schematic structural diagram of the detector according to the embodiment of the present application;

FIG. 7 is a fifth schematic structural diagram of the detector according to the embodiment of the present application;

FIG. 8 is a schematic structural diagram of a signal collection system according to an embodiment of the present application;

FIG. 9 is a schematic flow diagram of an imaging method according to an embodiment of the present application;

FIG. 10 is a structural block diagram of an imaging apparatus according to an embodiment of the present application; and

FIG. 11 is an internal structure diagram of a computer device according to an embodiment of the present application.

### DETAILED DESCRIPTION

The present application will be described in further detail below with reference to the accompanying drawings and embodiments in order to make the objects, technical solutions, and advantages of the present application more clear. It should be understood that the specific embodiments described herein are only for explaining the present application, and not intended to limit the present application.

Currently, more and more application scenarios require large-area detectors. However, a signal readout speed of the large-area detectors is not high. In view of this, the present application provides a detector, a signal collection system, an imaging method, a computer device, and a storage medium capable of improving the signal readout speed.

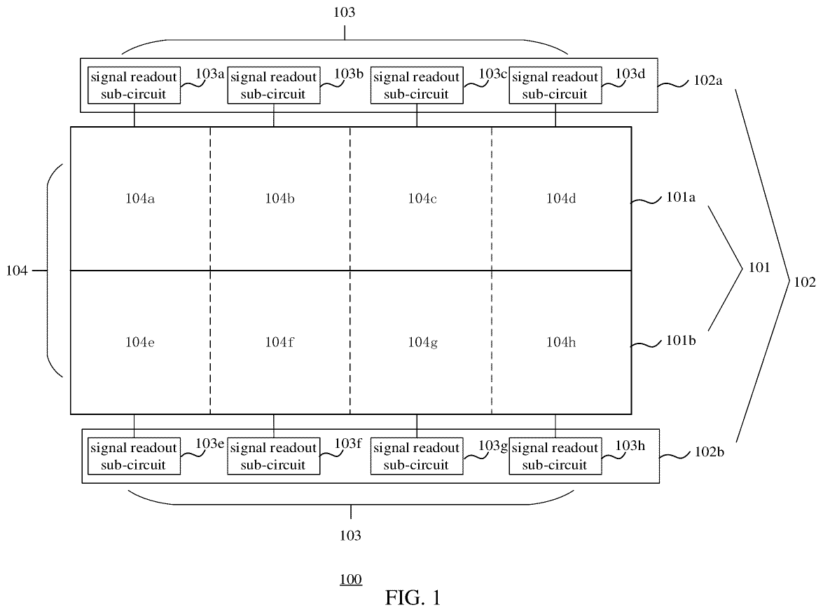

FIG. 1 is a first schematic structural diagram of a detector according to an embodiment of the present application, and the detector is, for example, a flat panel detector that converts radiation energy such as X-rays into an electrical signal or a digital signal and finally generates an image. As shown in FIG. 1, the detector 100 includes a plurality of detection regions 101 (e.g., 101a and 101b shown in FIG. 1) and signal readout circuits 102 (e.g., 102a and 102b shown in FIG. 1) in one-to-one correspondence with the plurality of detection regions 101 respectively. Each of the signal readout circuits 102 includes a plurality of signal readout sub-circuits 103 (e.g., 103a to 103h shown in FIG. 1), and the plurality of signal readout sub-circuits 103 are in one-to-one correspondence with a plurality of detection sub-regions 104 (e.g., 104a to 104h shown in FIG. 1) in the plurality of detection regions 101 respectively. The signal readout circuit 102 is connected to its corresponding detection region 101 respectively, and the signal readout sub-circuit 103 is connected to its corresponding detection subregion 104 respectively.

The plurality of detection regions 101 are regions obtained by dividing a plurality of pixels in the detector. It may be appreciated that pixels are basic units for signal collection, and the detector 100 according to the present application may be an area array detector capable of collecting information about entering of particles into a panel and distribution of the particles in the panel through the pixels arranged in an array. In other words, a single pixel collects information about the entering of the particle at a specific position in the panel. A process of collecting signals by the detector 101 includes particle receiving, signal conversion, signal amplification and processing, analog-to-digital conversion, output, control of the signal collection process, or the like, some of the functions are achieved in arrayed pixels, some are achieved by the signal readout circuit, and some are achieved by cooperation of the pixels and the signal readout circuit.

The pixels may be of different types or include different elements depending on a detector principle. For example, in a scintillator detector, the pixel may include a scintillator or a photodiode. In a semiconductor detector, the pixel may include a semiconductor, and incoming particles can be converted into an electrical signal by applying an electric field through the semiconductor.

The plurality of detection regions 101 may have the same size or different sizes. For example, the plurality of detection regions 101 may be obtained by equally dividing the plurality of pixels in the detector, and in this case, numbers of the pixels in the plurality of detection regions 101 are the same, and areas of the plurality of detection regions 101 are the same. In some embodiments, the plurality of pixels in the detector may alternatively be divided into a plurality of detection regions with different areas according to an imaging requirement, which is not limited in this embodiment.

As an example, each of the detection regions may include all pixels in an entire column (or an entire row) or multiple entire columns (or multiple entire rows) on the detector. As another example, each of the detection regions may be a non-entire-row region and/or a non-entire-column region on the detector, that is, each of the detection regions may be the region formed by partial of pixels of the detector in a row direction and/or a column direction. For example, in an example in which the detector includes 4260×4260 pixels, one detection region may be a region composed of 1000× 1000 pixels at the center, may also be a region composed of 2130×2130 pixels at the upper left corner, may also be a trapezoidal region, a T-shaped region, an L-shaped region, a non-regular shaped region, etc.

The plurality of detection sub-regions 104 are regions obtained by dividing a plurality of pixels in the detection region 101. Similarly, areas of the plurality of detection sub-regions 104 may be the same or different. For example, the detection region may be equally divided into the plurality of detection sub-regions 104.

With continued reference to FIG. 1, for example, the detection regions 101 include the detection region 101a and the detection region 101b, the detection region 101a corresponds to the signal readout circuit 102a, and the detection region 101b corresponds to the signal readout circuit 102b. It may be understood that FIG. 1 exemplifies 2 detection regions, each of the detection regions includes 4 detection sub-regions, and this embodiment does not limit numbers of the detection regions and the detection sub-regions.

The detection region 101a may include the detection sub-region 104a, the detection sub-region 104b, the detection sub-region 104c, and the detection sub-region 104d. The detection region 101b may include the detection sub-region 104e, the detection sub-region 104f, the detection sub-region 104g, and the detection sub-region 104h. The detection sub-region 104a corresponds to the signal readout sub-circuit 103a, the detection sub-region 104b corresponds to the signal readout sub-circuit 103b, . . . and so forth, and the detection sub-region 104h corresponds to the signal readout sub-circuit 103h.

Further, each pixel in the detection sub-region 104 is connected to the corresponding signal readout sub-circuit 103, and taking FIG. 1 as an example, each pixel in the detection sub-region 104a is connected to the signal readout sub-circuit 103a. The signal readout sub-circuit 103 may include, but is not limited to, an analog-to-digital converter or a circuit containing an analog-to-digital converter. In this way, the signal readout sub-circuit 103 can be configured to read output signal(s) corresponding to one or more pixel(s) in the corresponding detection sub-region 104.

The signal readout circuit 102 is configured to acquire the output signals read by the plurality of signal readout sub-circuits 103. Taking FIG. 1 as an example, the signal readout circuit 102a can acquire the output signals read by the signal readout sub-circuits 103a to 103d respectively, and the signal readout circuit 102b can acquire the output signals read by the signal readout sub-circuits 103e to 103h respectively.

It should be noted that the plurality of signal readout circuits 102 may work in parallel or in series. In other words, the signal readout circuits 102 may acquire the corresponding output signals in sequence or at the same time.

In some embodiments, optionally, the plurality of detection regions 101 in the detector 100 may have same attribute parameters. For example, the identical detector is adopted for all the detection regions 101. In this way, signal readout of each detection region 101 is facilitated. Taking CT scanning as an example, corresponding CT scanning can be completed at a higher speed based on the above detector 100. Moreover, compared with the flat panel detector in the related art, under the condition that a CT device rotates at the same rotating speed, more-angle projection images can be obtained without changing a delay theoretical upper limit of a readout system.

The detector includes the plurality of detection regions and the plurality of signal readout circuits, the plurality of signal readout circuits are in one-to-one correspondence with the plurality of detection regions respectively, each of the detection regions includes the plurality of detection sub-regions, each of the signal readout circuits includes the plurality of signal readout sub-circuits, and the plurality of signal readout sub-circuits are in one-to-one correspondence with the plurality of detection sub-regions respectively, so that each of the signal readout sub-circuits can read the output signal(s) corresponding to one or more pixel(s) in the corresponding detection sub-region, and the signal readout circuit can acquire the output signals read by the plurality of signal readout sub-circuits. Each signal readout circuit corresponds to the single detection region in the detector rather than the monolithic flat panel detector. In this way, the numbers of the signal readout circuits and the signal readout sub-circuits are increased, each detection region corresponds to an independent signal readout circuit, and each detection sub-region in each detection region corresponds to an independent signal readout sub-circuit, thereby improving the signal readout speed of the detector.

In an exemplary embodiment, optionally, at least two detection regions have different pixel attribute parameters.

The pixel attribute parameters of the detection region refer to parameters that can change performances of the pixels in the detector, and may include, but are not limited to, a type, resolution, collection speed, material, or the like, of the detector. For example, the detector may be of a direct or indirect type, or may be of a photon counting type, energy integrating type or other types.

At this point, at least two detection regions may have different pixel attribute parameters. Exemplarily, taking FIG. 1 as an example, the type of the detector in the detection region 101a may be type A, and the type of the detector in the detection region 101b may be type B different from type A, so that the performance of the pixels in the detection region 101a and the performance of the pixels in the detection region 101b may be different, so as to integrate different collection requirements into a same detector.

In some embodiments, the pixel attribute parameters of a preset region in the detection region of the detector are higher than those of other regions in the detection region of the detector. The other regions refer to the detection regions of the detector except the preset region in the detection region. The preset region may be set as desired. Exemplarily, since a central part of the image generated based on the detector is concerned, the preset region may be a central part of the detector. That is, the pixel attribute parameters of the detection region located in the central part of the detector may be set higher to improve detection precision of the central part of the detector, thereby improving quality of the central part of the image.

Since the attribute parameters of the pixels in the at least two detection regions are different, the attribute parameters can be set according to different requirements, and flexibility of the detector is improved.

In an exemplary embodiment, optionally, at least two signal readout circuits may have different attribute parameters.

In this embodiment, similarly, the attribute parameters of the signal readout circuit refer to parameters capable of changing a performance of the signal readout circuit, and may include, but are not limited to, an element type, a material, or the like, of the signal readout circuit. In this way, the flexibility of the detector can be improved by making at least two signal readout circuits having different attribute parameters.

Continuing with the example of FIG. 1, the material of the signal readout circuit 102a may be of material A, and the material of the signal readout circuit 102b may be of material B different from material A, so that the performance of the signal readout circuit 102a and the performance of the signal readout circuit 102b may be different, so as to integrate different collection requirements into the same detector.

In an exemplary embodiment, at least two detection regions may have different pixel attribute parameters, and the at least two signal readout circuits may also have different attribute parameters.

In an exemplary embodiment, optionally, the detection region is parallel to a corresponding tomographic reconstruction plane of a scanning device.

That is, projection data corresponding to each reconstructed tomographic layer may be from the same detection region. That is, the detection region is parallel to the tomographic reconstruction plane and perpendicular to a rotation axis, so that a corresponding tomographic image can be reconstructed from information collected by one turn of the detection region. It may be readily appreciated that the scanning device is configured to scan a detected object by transmitting radiation energy such as X-rays through the object, and the detector is configured to receive an energy signal after passing through the object and convert the energy signal into an electrical or digital signal for subsequent processing.

In the above embodiment, the detection region is parallel to the tomographic reconstruction plane corresponding to the scanning device, so that on the one hand, the signal readout circuits corresponding to the detection regions can improve a generation efficiency of the images corresponding to the tomographic layers, and on the other hand, the pixel attribute parameters of the plurality of detection regions or the attribute parameters of the corresponding signal readout circuits can be set to flexibly obtain the images corresponding to the tomographic layers according to actual requirements.

In an exemplary embodiment, optionally, the plurality of signal readout circuits are arranged on a plurality of circuit layers of the same circuit board respectively. Taking FIG. 1 as an example, the signal readout circuit 102a may be arranged on a first circuit layer of the circuit board, and the signal readout circuit 102b may be arranged on a second circuit layer of the circuit board, which is beneficial to controlling multiple signal readout circuits through the same circuit board, thus improving integration of the detector. In some examples, the plurality of circuit layers may be controlled independently of each other.

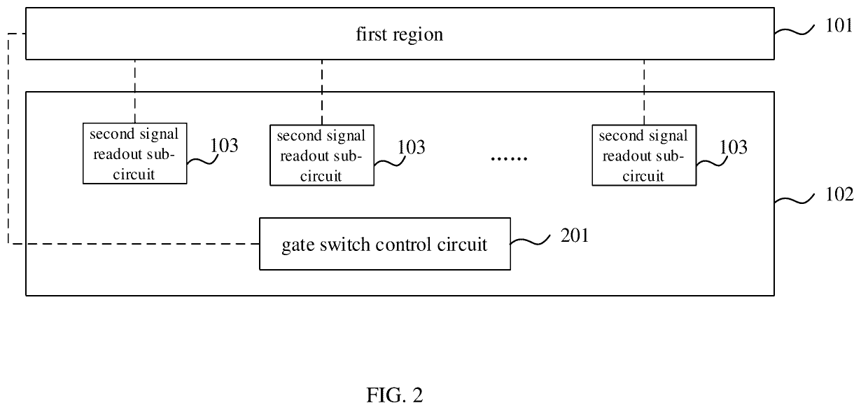

FIG. 2 is a schematic structural diagram of the signal readout circuit in the embodiment of the present application, and with continued reference to FIG. 2, in an exemplary embodiment, optionally, each of the signal readout circuits 102 includes a gate switch control circuit (also referred to as a gate control circuit) 201.

The gate switch control circuit 201 is connected to each pixel in the detection region 101. The gate switch control circuit 201 is configured to turn on a target pixel in the detection region 101 by outputting a gating signal corresponding to the target pixel. It may be understood that the gating signal corresponding to the target pixel is used to indicate that the target pixel is turned on. That is, the output signal corresponding to the target pixel can be obtained. If a pixel is not gated, the output signal corresponding to the pixel cannot be acquired.

That is, the gate switch control circuit 201 can control each pixel in the detection region 101 to be turned on or off, and in the case of turning on the target pixel in the detection region 101, output the gating signal corresponding to the target pixel. The target pixel refers to at least one pixel among the plurality of pixels of the detection region 101.

Exemplarily, assuming that the detection region 101 includes pixels A to H, and the pixels A to H in the detection region 101 are in an off state, the gate switch control circuit 201 may turn on the pixel A in the detection region 101 and output the gating signal corresponding to the pixel A in the detection region 101.

In the above embodiment, since the signal readout circuit includes the gate switch control circuit, and the gate switch control circuit can turn on the target pixel in the detection region by outputting the gating signal corresponding to the target pixel, control precision of the detector is improved.

In an exemplary embodiment, optionally, the signal readout sub-circuit is configured to acquire an output signal of the detection sub-region corresponding to the target pixel under the condition that the target pixel is turned on.

In this embodiment, the signal readout sub-circuit 103 can acquire the output signal of the detection sub-region 101 corresponding to the target pixel under the condition that the target pixel is turned on. Continuing with the above example, in the case of turning on the pixel A in the detection region 101, the signal readout sub-circuit 103 corresponding to the pixel A in the detection region 101 can acquire the output signal of the pixel A in the detection region 101.

In the above embodiment, since the signal readout sub-circuit can be configured to acquire the output signal of the detection sub-region corresponding to the target pixel under the condition that the target pixel is turned on, a signal readout efficiency is improved.

In an exemplary embodiment, the detection sub-region may include one or more pixels.

As an example, each of the detection sub-regions may include only one single pixel, that is, the detector may include a plurality of detection regions, each of the detection regions may include a plurality of pixels, and an output signal of each pixel is read by a corresponding signal readout sub-circuit; in other words, each pixel forms a detection sub-region. In another example, each of the detection sub-regions may include a plurality of pixels, that is, the detector may include a plurality of detection regions, each of the detection regions may include a plurality of detection sub-regions, each of the detection sub-regions may include a plurality of pixels, and an output signal of each of the detection sub-regions (i.e. including a plurality of pixels) is read by a corresponding signal readout sub-circuit.

In an exemplary embodiment, optionally, the detection sub-region is a region obtained by dividing the plurality of pixels in the detection region according to a preset dividing manner, and the preset dividing manner may include a pixel row dividing manner, a pixel column dividing manner, or a pixel block dividing manner.

Taking the pixel row dividing manner as an example, in the process of dividing the detection region into the detection sub-regions, each row of pixels in the detection region may correspond to one detection sub-region, and if the detection region includes 3 rows and 5 columns of pixels, 3 detection sub-regions may be obtained according to the pixel row dividing manner.

Taking the pixel column dividing manner as an example, each column of pixels in the detection region may correspond to one detection sub-region, and if the detection region includes 3 rows and 5 columns of pixels, 5 detection sub-regions may be obtained according to the pixel column dividing manner.

It can be understood that, in the above description, division is performed based on every row or every column as an example, and this embodiment does not limit a specific division number of the pixel row dividing manner or the pixel column dividing manner. For example, every two rows of pixels in the detection region may correspond to one detection sub-region.

Taking the pixel block dividing manner as an example, the detection region may be divided according to pixel blocks of various shapes to obtain the plurality of detection sub-regions. The shape of the pixel block may include, but is not limited to, a rectangle, a square, a T-shape, an L-shape, or the like, and this embodiment is not limited thereto.

In the above embodiment, the preset dividing manner includes the pixel row dividing manner, the pixel column dividing manner, or the pixel block dividing manner, so that after the plurality of pixels in the detection region are divided according to the preset dividing manner, the plurality of detection sub-regions can be flexibly and efficiently obtained. For example, one or more pixels in the detection sub-region may be adaptively turned on or off according to a movement region or trajectory of an imaging beam during imaging scanning.

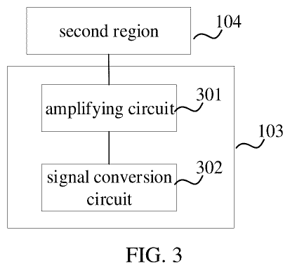

FIG. 3 is a schematic structural diagram of the signal readout sub-circuit in the embodiment of the present application, and as shown in FIG. 3, in an exemplary embodiment, optionally, the signal readout sub-circuit 103 includes an amplifying circuit 301 and a signal conversion circuit 302. As a non-limiting embodiment, the amplifying circuit 301 includes, but is not limited to, an amplifier, and the signal conversion circuit 302 includes, but is not limited to, an analog-to-digital converter. The amplifying circuit 301 and the signal conversion circuit 302 may be or include any circuit or device capable of achieving the corresponding functions.

The amplifying circuit 301 is configured to amplify a first signal of the target pixel and send the first signal to the signal conversion circuit 302. The signal conversion circuit 302 is configured to obtain the output signal corresponding to the target pixel according to the first signal. That is, in the case where the target pixel is turned on, the amplifying circuit 301 can acquire the first signal of the target pixel and send the first signal to the signal conversion circuit 302 to obtain the output signal corresponding to the target pixel by the signal conversion circuit 302.

In the above embodiment, the signal readout sub-circuit includes the amplifying circuit and the signal conversion circuit. Since the amplifying circuit can amplify the first signal of the target pixel and send the first signal to the signal conversion circuit, the signal conversion circuit can obtain the output signal corresponding to the target pixel according to the first signal. Therefore, the signal readout sub-circuit can read the output signals corresponding to one or more pixel(s) in the detection sub-region.

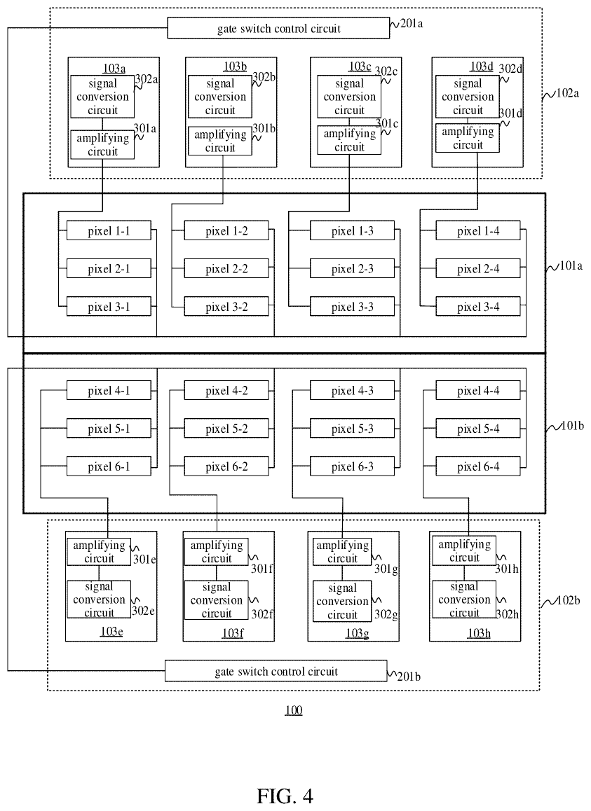

In order to more clearly describe the detector according to the present application, the detector is described with reference to FIG. 4 to FIG. 7. FIG. 4 is a second schematic structural diagram of the detector according to the embodiment of the present application, and for example, the detector 100 includes 6 rows and 4 columns of pixels 1-1 to 6-4, and the plurality of pixels may be divided into a detection region 101a and a detection region 101b. The detection region 101a includes the pixels 1-1 to 3-4, and the detection region 101b includes the pixels 4-1 to 6-4.

Taking the detection region 101a as an example, each column of pixels in the detection region 101a is taken as one detection sub-region, and the signal readout sub-circuit 103a corresponding to the first column of pixels in the detection region 101a can be determined. The signal readout sub-circuit 103b corresponding to the second column of pixels in the detection region 101a can be determined, and so on. Further, the signal readout sub-circuit 103a includes an amplifying circuit 301a and a signal conversion circuit 302a, the signal readout sub-circuit 103b includes an amplifying circuit 301b and a signal conversion circuit 302b, the signal readout sub-circuit 103c includes an amplifying circuit 301c and a signal conversion circuit 302c, and the signal readout sub-circuit 103d includes an amplifying circuit 301d and a signal conversion circuit 302d.

Further, each pixel in the detection region 101a is connected to a gate switch control circuit 201a in the signal readout circuit 102a. Exemplarily, assuming that the signal readout circuit 102a turns on the pixel 1-1, the amplifying circuit 301a amplifies a first signal of the pixel 1-1 and sends the first signal of the pixel 1-1 to the signal conversion circuit 302a, and then, the signal conversion circuit 302a determines an output signal of the first signal of the pixel 1-1 according to the first signal of the pixel 1-1.

Similarly in the detection region 101b, the signal readout sub-circuit 103e includes an amplifying circuit 301e and a signal conversion circuit 302e, the signal readout sub-circuit 103f includes an amplifying circuit 301f and a signal conversion circuit 302f, the signal readout sub-circuit 103g includes an amplifying circuit 301g and a signal conversion circuit 302g, and the signal readout sub-circuit 103h includes an amplifying circuit 301h and a signal conversion circuit 302h. Details are not repeated herein.

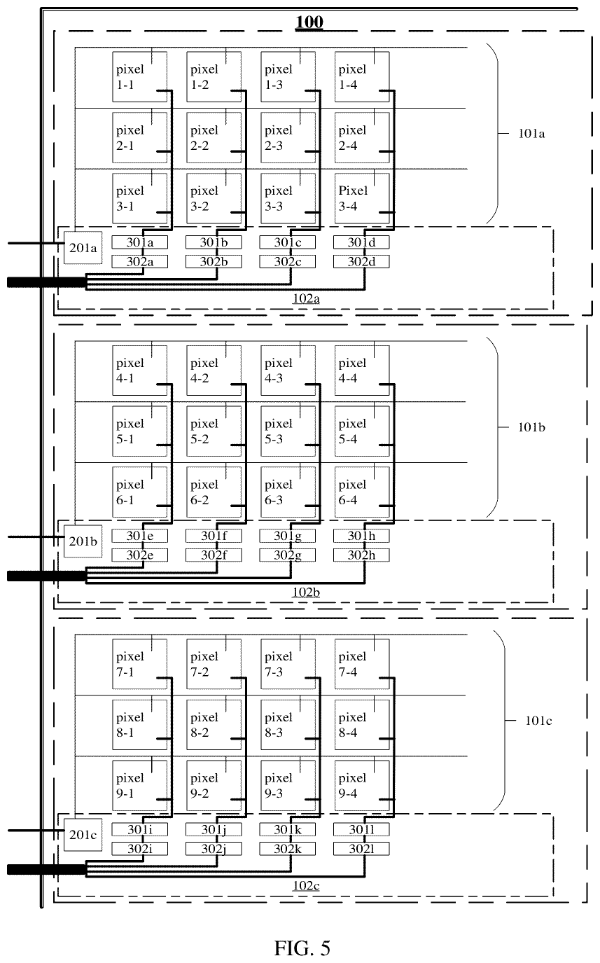

FIG. 5 is a third schematic structural diagram of the detector according to the embodiment of the present application, and as shown in FIG. 5, based on FIG. 4, for example, the detector 100 includes 9 rows and 4 columns of pixels, the plurality of pixels may be divided into a detection region 101a, a detection region 101b, and a detection region 101c, and the detection region 101c includes pixels 7-1 to 9-4.

Similar to a principle of FIG. 4, a signal readout circuit 102c corresponding to the detection region 101c includes a gate switch control circuit 201c, amplifying circuits 301i to 3011, and signal conversion circuits 302i to 3021, which are not repeated herein. It should be noted that the letters in the present application are only for distinguishing examples and do not limit numbers.

Currently, application of a detector with a large view field to high-rotation-speed CT image collection still has a bottleneck, and in a large-view-field and high-rotation-speed CT imaging system which simultaneously collects human respiratory movement, or the like, due to a limitation of a collection speed, the rotation speed has to be reduced, or collection is performed by adopting sparse angles, resulting in a reconstruction artifact. In the above detector 100, the plurality of pixels of the detector are divided into the plurality of detection regions, and attribute information of the pixels in each detection region or attribute information of the signal readout circuit can be individually selected. On the one hand, rapid signal reading can be realized, and on the other hand, since flat panel detectors with different type, property, and performance parameters have respective advantages and limitations, by combining different noise models and different artifacts, it is beneficial to extracting richer and more accurate information. Thus, this embodiment is favorable for combining the advantages of different detectors. For example, detectors with different detection efficiencies, collection speeds, and resolutions can be combined. Exemplarily, taking CT scanning as an example, since X-ray detection principles and properties corresponding to different types, properties, and performances of detectors have differences, if collection by different detectors in the adjacent regions is combined, more or more accurate images and information about substance can be obtained.

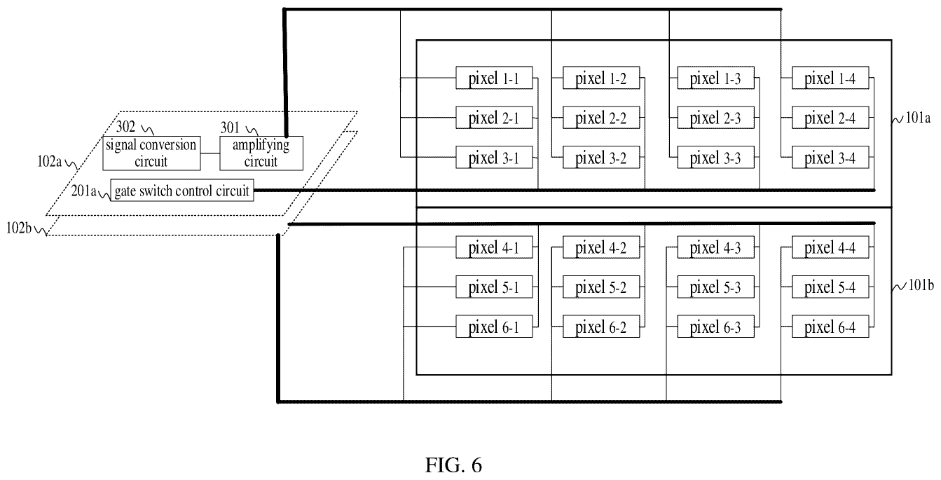

FIG. 6 is a fourth schematic structural diagram of the detector according to the embodiment of the present application, and as shown in FIG. 6, on the basis of FIG. 4 in which the plurality of pixels are divided into the detection region 101a and the detection region 101b, taking the detection region 101a as an example, the amplifying circuit 301a, the amplifying circuit 301b, the amplifying circuit 301c, and the amplifying circuit 301d may be integrated together to obtain the amplifying circuit 301 in the signal readout circuit 102a, and the signal readout circuit 302a, the signal readout circuit 302b, the signal readout circuit 302c, and the signal readout circuit 302d may be integrated together to obtain the signal readout circuit 302 in the signal readout circuit 102a. Further, the signal readout circuit 102a including the amplifying circuit 301, the signal readout circuit 302, and the door switch control circuit 201a is arranged on a first circuit layer of the circuit board. Similarly in the detection region 101b, and the signal readout circuit 102b corresponding to the detection region 101b is arranged on a second circuit layer of the circuit board. Optionally, the first circuit layer and the second circuit layer may be controlled independently of each other.

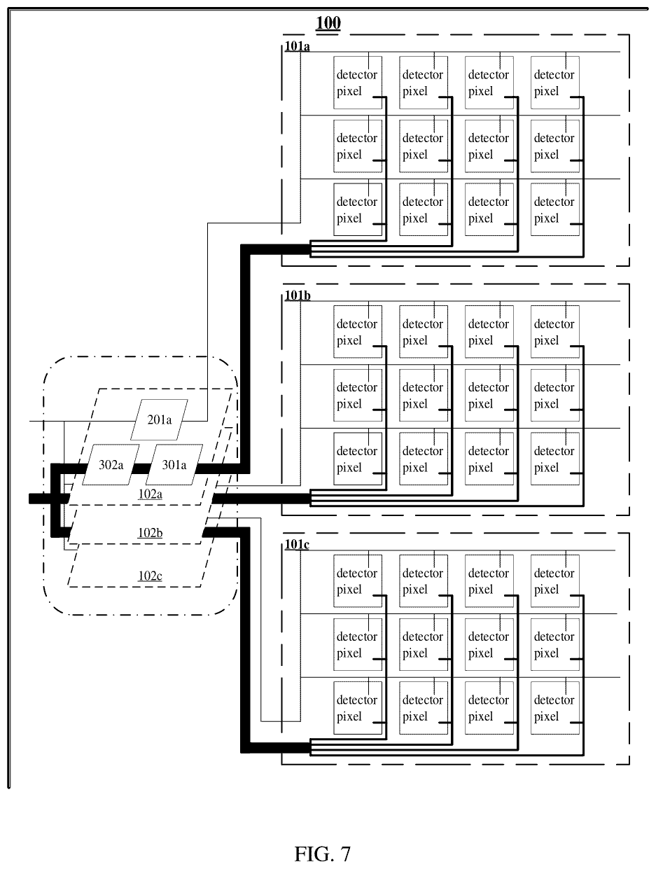

FIG. 7 is a fifth schematic structural diagram of the detector according to the embodiment of the present application, and as shown in FIG. 7, on the basis of FIG. 5 in which the plurality of pixels are divided into the detection region 101a, the detection region 101b, and the detection region 101c, taking the detection region 101a as an example, the gate switch control circuit 201a, the amplifying circuit 301a, and the signal conversion circuit 302a corresponding to the detection region 101 can be integrated together to obtain the signal readout circuit 102a. The signal readout circuit 102b corresponding to the detection region 101b and the signal readout circuit 102c corresponding to the detection region 101c are similar, and are not repeated herein.

In an embodiment, optionally, the signal readout circuit 102a, the signal readout circuit 102b, and the signal readout circuit 102c may be arranged on different circuit layers in the circuit board. Optionally, the multiple circuit layers in the circuit board may be controlled independently of each other. Thus, control and signal readout of different detection regions can be controlled simultaneously by one independent control chip. The control chip includes the circuit board.

Thus, in the detector according to this embodiment, from the perspective of the system, since the detector includes the plurality of detection regions, a multi-stage and parallel control and signal transmission solution may be adopted for control and information collection of the detector, which is beneficial to realizing simultaneous controlling and signal transmission of the plurality of detection regions. From the perspective of an algorithm, since the detector includes the plurality of detection regions, adoption of an original rapid algorithm may realize high-speed information extraction and image reconstruction, and then realize high-speed imaging and information extraction combining a plurality of detectors.

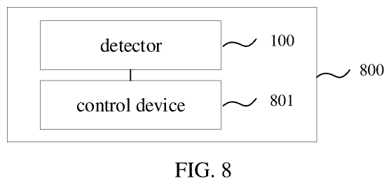

FIG. 8 is a schematic structural diagram of a signal collection system according to an embodiment of the present application, and as shown in FIG. 8, the present application further provides a signal collection system 800 including a control device 801 and a detector 100.

The control device 801 may be, but not limited to, various personal computers, notebook computers, smart phones, tablet computers, and portable wearable devices, and the portable wearable devices may be smart watches, smart bracelets, head-mounted devices, or the like, and certainly, the control device 801 may also be implemented by an independent server or a server cluster formed by multiple servers.

In some embodiments, the control device 801 may alternatively be arranged inside the detector 100, and the control device 801 includes, but is not limited to, at least one of a central processing unit (CPU), a digital signal processor (DSP), a field-programmable gate array (FPGA), or other programmable logic devices.

The control device 801 may be connected to each of a plurality of signal readout circuits 102, and then, the control device 801 may acquire output signals corresponding to a plurality of pixels from the plurality of signal readout circuits 102.

Further optionally, the control device 801 may further obtain a gating signal corresponding to a target pixel from a gate switch control circuit 201, so as to obtain an output signal corresponding to the target pixel from the signal conversion circuits in the multiple signal readout circuits 102.

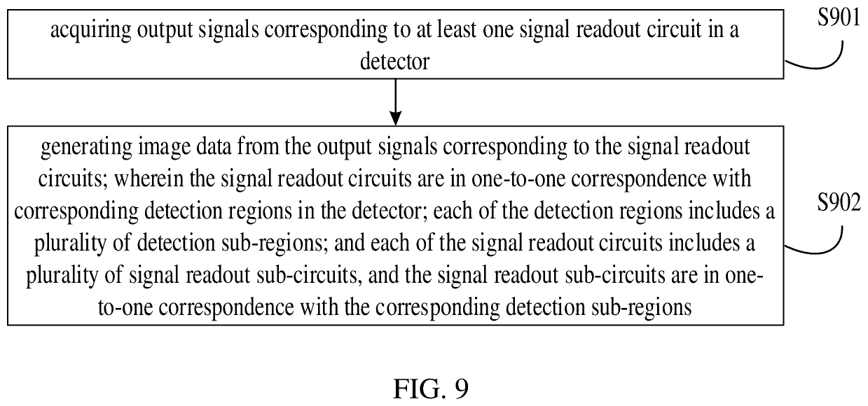

The present application further provides an imaging method. FIG. 9 is a schematic flow diagram of an imaging method according to an embodiment of the present application, and in an exemplary embodiment, as shown in FIG. 9, an imaging method is provided, which may be applied to the control device 801 in FIG. 8, or may be applied to other computer devices, and includes the following S901 to S902.

S901: acquiring output signals corresponding to a plurality of signal readout circuits in a detector.

S902: generating image data from the output signals corresponding to the plurality of signal readout circuits; wherein the plurality of signal readout circuits are in one-to-one correspondence with a plurality of detection regions in the detector respectively; each of the detection regions includes a plurality of detection sub-regions; and each of the signal readout circuits includes a plurality of signal readout sub-circuits, and the plurality of signal readout sub-circuits are in one-to-one correspondence with the plurality of detection sub-regions respectively. The image data may be or include an image, or may be or include intermediate data for obtaining the image. For example, the image may be or include a computed tomography (CT) image (such as a fan-beam CT image and a cone-beam CT image), a digital radiography (DR) image, or the like. As a non-limiting example, the intermediate data may include raw data from analog-to-digital conversion of an electrical signal, Sinograms for image reconstruction, or the like.

In this embodiment, taking FIG. 1 as an example, the control device 801 may acquire the output signal corresponding to the signal readout circuit 102a and acquire the output signal corresponding to the signal readout circuit 102b. The output signals corresponding to the signal readout circuit 102a are output signals read by the signal readout sub-circuits 103a to 103d respectively, and the output signals corresponding to the signal readout circuit 102b are output signals read by the signal readout sub-circuits 103e to 103h respectively.

Then, the control device 801 may perform reconstruction according to the output signal corresponding to the signal readout circuit 102a and the output signal corresponding to the signal readout circuit 102b to obtain the corresponding image. Taking CT scanning as an example, the image may be a three-dimensional CT image or a two-dimensional CT image, which is not limited in this embodiment.

In some embodiments, the control device not only needs the output signals corresponding to the signal readout circuits, but also needs to acquire gating signals corresponding to the output signals, so as to generate the image from the output signals and the gating signals corresponding to the plurality of signal readout circuits. It may be appreciated that the gating signal and the output signal of the same pixel have a matching relationship.

In the above imaging method, the plurality of signal readout circuits are in one-to-one correspondence with the plurality of detection regions in the detector respectively; each of the detection regions includes the plurality of detection sub-regions; and each of the signal readout circuits includes the plurality of signal readout sub-circuits, the plurality of signal readout sub-circuits are in one-to-one correspondence with the plurality of detection sub-regions respectively, and each of the signal readout circuit corresponds to the single detection region in the detector rather than a monolithic flat panel detector. In this way, the numbers of the signal readout circuits and the signal readout sub-circuits are increased, each detection region corresponds to an independent signal readout circuit, and each detection sub-region in each detection region corresponds to an independent signal readout sub-circuit, thereby improving the signal readout speed of the detector. Further, since the output signal corresponding to at least one signal readout circuit in the detector can be acquired and the image can be generated from the output signals corresponding to the plurality of signal readout circuits, an efficiency of generating the image is also improved.

In an exemplary embodiment, the above imaging method further includes the following step.

At least two output signals in the output signals corresponding to the plurality of signal readout circuits are analyzed to obtain an analysis result; a time difference value between acquisition times of any two output signals in the at least two output signals is smaller than a preset difference value.

In this embodiment, the analysis result may be used to indicate a difference between the output signals. The time difference value between the acquisition times is smaller than a preset difference value, that is, signal readout speeds between the detection region and the detection sub-region are synchronous. The preset difference value may be set as required, for example, the preset difference value is a number close to 0, for example, may be several millisecond, such as 1 millisecond, 0.5 milliseconds, or 0.1 milliseconds, or the like.

Continuing with the example of FIG. 1 and FIG. 8, the control device 801 may control the signal readout circuit 102a and the signal readout circuit 102b to simultaneously work, simultaneously obtain the output signal A and the output signal B corresponding to the signal readout circuit 102a, and then analyze the output signal A and the output signal B to obtain the analysis result.

In some embodiments, the detection regions corresponding to the at least two output signals may be adjacent detection regions and performances between the detection regions corresponding to the at least two output signals may be different. Continuing with the example of FIG. 1, the pixel attribute parameter of the detection region 101a may be attribute parameter A, the pixel attribute parameter of the detection region 101b may be attribute parameter B different from attribute parameter A, and the detection region 101a and the detection region 101b are two adjacent regions in the detector. Thus, the obtained analysis result can indicate a difference between the corresponding output signals of the detectors with different performances.

In the above embodiment, since the time difference value between the acquisition times of any two of the at least two output signals is smaller than the preset difference value, by analyzing the at least two of the output signals corresponding to the plurality of signal readout circuits to obtain the analysis result, the at least two detection regions can be analyzed.

By the embodiments of the present application, an imaging region of the detector can be flexibly and variably controlled during imaging, thereby reducing power consumption, and reducing a load of the signal readout circuit, for example. As a specific embodiment, when an imaging manner is CT or DR imaging, one or more pixels in a detection sub-region where a projection of an imaging X-ray beam is located and/or a corresponding signal readout sub-circuit thereof may be dynamically and selectively turned on or off according to a movement trajectory of the projection of the imaging X-ray beam emitted by an imaging source onto the detector, so as to track the imaging X-ray beam for imaging. As a further specific example, when the imaging mode is CT or DR imaging, a detection region and/or a detection sub-region corresponding to a space where a region of interest is located may be set to have higher detection precision (e.g., using high-precision imaging pixels, activating a high-resolution imaging mode of pixels, etc.) according to a spatial position of the region of interest to be imaged within a whole imaging field range, and detection regions and/or detection sub-regions corresponding to other spaces are set to have lower precision (e.g., using low-precision imaging pixels, activating a low-resolution imaging mode of pixels, etc.), so that a cost can be saved, and imaging precision is slightly or not reduced.

It should be understood that, although the steps in the flow charts involved in the above embodiments are shown in sequence as indicated by the arrows, the steps are not necessarily performed in sequence as indicated by the arrows. Unless explicitly stated herein, the steps are not limited to being performed in the exact order and may be performed in other orders. At least part of the steps in the flow charts involved in the above embodiments may include multiple steps or multiple stages, which are not necessarily performed at the same moment, but may be performed at different moments, and the steps or the stages are not necessarily performed in sequence, but may be performed alternately with other steps or at least part of the steps or the stages in other steps.

Based on the same inventive concept, the embodiment of the present application further provides an imaging apparatus for implementing the above imaging method. The implementation solution for solving problems provided by the apparatus is similar to the implementation solution described in the above method, and therefore, for the specific definitions in one or more embodiments of the imaging apparatus provided below, reference can be made to the definitions of the imaging method in the above description, and the definitions are not repeated herein.

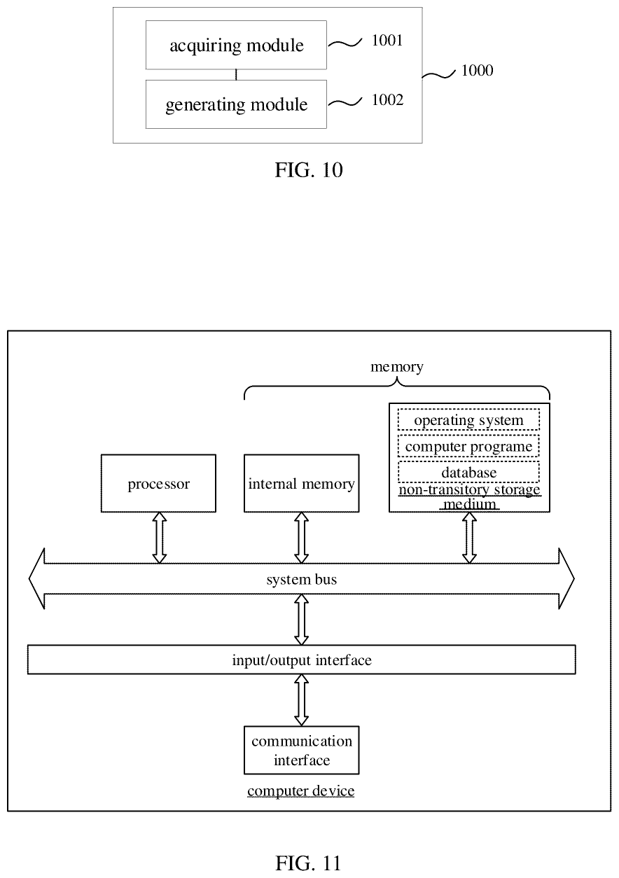

FIG. 10 is a structural block diagram of an imaging apparatus according to an embodiment of the present application, and in an exemplary embodiment, as shown in FIG. 10, an imaging apparatus 1000 is provided and includes:
an acquiring module 1001 configured to acquire output signals corresponding to a plurality of signal readout circuits in a detector; and
a generating module 1002 configured to generate an image from the output signals corresponding to the plurality of signal readout circuits; wherein the plurality of signal readout circuits are in one-to-one correspondence with a plurality of detection regions in the detector respectively; each of the detection regions includes a plurality of detection sub-regions; and each of the signal readout circuits includes a plurality of signal readout sub-circuits, and the plurality of signal readout sub-circuits are in one-to-one correspondence with the plurality of detection sub-regions respectively.

In the imaging apparatus, the plurality of signal readout circuits are in one-to-one correspondence with the plurality of detection regions in the detector respectively; each of the detection region includes the plurality of detection sub-regions; and each of the signal readout circuits includes the plurality of signal readout sub-circuits, the plurality of signal readout sub-circuits are in one-to-one correspondence with the plurality of detection sub-regions respectively, and each of the signal readout circuit corresponds to the single detection region in the detector rather than a monolithic flat panel detector. In this way, the numbers of the signal readout circuits and the signal readout sub-circuits are increased, each detection region corresponds to an independent signal readout circuit, and each detection sub-region in each detection region corresponds to the independent signal readout sub-circuit, thereby improving the signal readout speed of the detector. Further, since the output signal corresponding to at least one signal readout circuit in the detector can be acquired and the image can be generated from the output signals corresponding to the plurality of signal readout circuits, an efficiency of generating the image is also improved.

Optionally, the imaging apparatus 1000 further includes:
an analyzing module configured to analyze at least two output signals in the output signals corresponding to the plurality of signal readout circuits to obtain an analysis result; a time difference value between acquisition times of any two output signals in the at least two output signals being smaller than a preset difference value.

The modules in the imaging apparatus may be wholly or partially implemented by software, hardware and a combination thereof. The modules may be embedded in or independent of the processor in the computer device in hardware, or may be stored in the memory in the computer device in software, such that the processor can conveniently call the modules to execute the operations corresponding to the modules.

FIG. 11 is an internal structure diagram of a computer device according to an embodiment of the present application, and in an exemplary embodiment, there is provided a computer device, which may be a server, an internal structure diagram of which may be shown in FIG. 11. The computer device includes a processor, a memory, an input/output (I/O) interface, and a communication interface. The processor, the memory, and the input/output interface are connected through a system bus, and the communication interface is connected to the system bus through the input/output interface. The processor of the computer device is configured to provide computing and control capabilities. The memory of the computer device includes a non-transitory storage medium and an internal memory. The non-transitory storage medium stores an operating system, a computer program, and a database. The internal memory provides an environment for running of the operating system and the computer program in the non-transitory storage medium. The database of the computer device is configured to store related data. The input/output interface of the computer device is configured to exchange information between the processor and an external device. The communication interface of the computer device is configured to be communicated with an external terminal through a network connection. The computer program is executed by the processor to implement an imaging method.

Those skilled in the art will appreciate that the structure shown in FIG. 11 is only a block diagram of a part of the structure associated with the application solution and does not constitute a limitation on the computer device to which the application solution is applied, and a particular computer device may include more or fewer components than shown components, or combine certain components, or have a different arrangement of components.

In an embodiment, there is provided a computer device, including a memory and a processor, the memory storing a computer program, and the processor implementing the following steps when executing the computer program:
acquiring output signals corresponding to a plurality of signal readout circuits in a detector; and
generating an image from the output signals corresponding to the plurality of signal readout circuits;
wherein the plurality of signal readout circuits are in one-to-one correspondence with a plurality of detection regions in the detector respectively; each of the detection regions includes a plurality of detection sub-regions; and each of the signal readout circuits includes a plurality of signal readout sub-circuits, and the plurality of signal readout sub-circuits are in one-to-one correspondence with the plurality of detection sub-regions respectively.

In an embodiment, the processor also implements the following step when executing the computer program:
analyzing at least two output signals in the output signals corresponding to the plurality of signal readout circuits to obtain an analysis result; a time difference value between acquisition times of any two output signals in the at least two output signals being smaller than a preset difference value.

In an embodiment, there is provided a non-transitory computer-readable storage medium having a computer program stored thereon, the computer program, when executed by a processor, implementing the following steps:
acquiring output signals corresponding to a plurality of signal readout circuits in a detector; and
generating an image from the output signals corresponding to the plurality of signal readout circuits;
wherein the plurality of signal readout circuits are in one-to-one correspondence with a plurality of detection regions in the detector respectively; each of the detection regions includes a plurality of detection sub-regions; and each of the signal readout circuits includes a plurality of signal readout sub-circuits, and the plurality of signal readout sub-circuits are in one-to-one correspondence with the plurality of detection sub-regions respectively.

In an embodiment, the computer program, when executed by the processor, also implements the following step:
analyzing at least two output signals in the output signals corresponding to the plurality of signal readout circuits to obtain an analysis result; a time difference value between acquisition times of any two output signals in the at least two output signals being smaller than a preset difference value.

In an embodiment, there is provided a computer program product including a computer program which, when executed by a processor, implements the following steps:
acquiring output signals corresponding to a plurality of signal readout circuits in a detector; and
generating an image from the output signals corresponding to the plurality of signal readout circuits;
wherein the plurality of signal readout circuits are in one-to-one correspondence with a plurality of detection regions in the detector respectively; each of the detection regions includes a plurality of detection sub-regions; and each of the signal readout circuits includes a plurality of signal readout sub-circuits, and the plurality of signal readout sub-circuits are in one-to-one correspondence with the plurality of detection sub-regions respectively.

In an embodiment, the computer program, when executed by the processor, also implements the following step:
analyzing at least two output signals in the output signals corresponding to the plurality of signal readout circuits to obtain an analysis result; a time difference value between acquisition times of any two output signals in the at least two output signals being smaller than a preset difference value.

It will be understood by those skilled in the art that all or part of the processes of the method according to the embodiments described above may be implemented by a computer program instructing related hardware, and the computer program may be stored in a non-transitory computer-readable storage medium, and when executed, may include the processes of the embodiments of the method described above. Any reference to memories, databases or other media used in the embodiments of the present application can include at least one of a non-transitory memory and a transitory memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, or the like. The transitory memory can include a random access memory (RAM), an external cache memory, or the like. By way of illustration and not limitation, the RAM can take many forms, such as a static random access memory (SRAM), a dynamic random access memory (DRAM), or the like. The databases involved in the embodiments of the present application may include at least one of relational and non-relational databases. The non-relational database may include, but is not limited to, a block chain-based distributed database, or the like. The processors referred to in the embodiments of the present application may include, but are not limited to, general processors, central processors, graphics processors, digital signal processors, programmable logic units, data processing logic units based on quantum calculations, or the like.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the specification.

The above-described embodiments are only several implementations of the present application, and the descriptions are relatively specific and detailed, but they should not be construed as limiting the scope of the present application. It should be understood by those of ordinary skill in the art that various modifications and improvements can be made without departing from the concept of the present application, and all fall within the protection scope of the present application. Therefore, the protection scope of the present application should be subject to the appended claims.

What is claimed is:

1. A detector, comprising:
a plurality of detection regions, each of the detection regions comprising a plurality of detection sub-regions; and
a plurality of signal readout circuits, the plurality of signal readout circuits being in one-to-one correspondence with the corresponding detection regions respectively, each of the signal readout circuits comprising a plurality of signal readout sub-circuits, and the plurality of signal readout sub-circuits being in one-to-one correspondence with the plurality of detection sub-regions respectively.

2. The detector according to claim 1, wherein at least two detection regions have different pixel attribute parameters.

3. The detector according to claim 2, wherein the pixel attribute parameters comprise at least one of a type, resolution, collection speed, and material of the detector.

4. The detector according to claim 2, wherein the pixel attribute parameters of a preset region in the detection region of the detector are higher than those of other regions in the detection region of the detector.

5. The detector according to claim 4, wherein the preset region is a central part of the detector.

6. The detector according to claim 1, wherein at least two signal readout circuits have different attribute parameters.

7. The detector according to claim 6, wherein the attribute parameter of the signal readout circuit comprises at least one of an element type and material of the signal readout circuit.

8. The detector according to claim 1, wherein the detection region is parallel to a corresponding tomographic reconstruction plane of a scanning device.

9. The detector according to claim 1, wherein the plurality of signal readout circuits are arranged on a plurality of circuit layers of the same circuit board respectively.

10. The detector according to claim 8, wherein the plurality of circuit layers are controlled independently of each other.

11. The detector according to claim 1, wherein the signal readout circuit comprises: a gate switch control circuit, the gate switch control circuit being configured to turn on a target pixel in the detection region by outputting a gating signal corresponding to the target pixel.

12. The detector according to claim 11, wherein the signal readout sub-circuit is configured to acquire an output signal of the detection sub-region corresponding to the target pixel under the condition that the target pixel is turned on.

13. The detector according to claim 1, wherein the detection sub-region is a region obtained by dividing a plurality of pixels in the detection region according to a preset dividing manner, and the preset dividing manner comprises a pixel row dividing manner, a pixel column dividing manner, or a pixel block dividing manner.

14. The detector according to claim 11, wherein each of the signal readout sub-circuits comprises an amplifying circuit and a signal conversion circuit;
the amplifying circuit is configured to amplify a first signal of the target pixel and send the first signal to the signal conversion circuit; and
the signal conversion circuit is configured to obtain an output signal corresponding to the target pixel according to the first signal.

15. The detector according to claim 1, wherein each of the plurality of detection regions is a region formed by partial of pixels of the detector in a row direction and/or a column direction.

16. An imaging method, comprising:
acquiring output signals corresponding to a plurality of signal readout circuits in a detector; and
generating image data from the output signals corresponding to the plurality of signal readout circuits;
wherein the plurality of signal readout circuits are in one-to-one correspondence with a plurality of detection regions in the detector respectively; each of the detection regions comprises a plurality of detection sub-regions; and each of the signal readout circuits comprises a plurality of signal readout sub-circuits, and the plurality of signal readout sub-circuits are in one-to-one correspondence with the plurality of detection sub-regions respectively.

17. The imaging method according to claim 16, further comprising:
analyzing at least two output signals in the output signals corresponding to the plurality of signal readout circuits to obtain an analysis result; a time difference value between acquisition times of any two output signals in the at least two output signals being smaller than a preset difference value.

18. The imaging method according to claim 16, wherein generating the image data from the output signals corresponding to the plurality of signal readout circuits comprises:
generating the image data according to the output signals and gating signals corresponding to the plurality of signal readout circuits;
wherein the gating signal and the output signal of the same pixel have a matching relationship.

19. The imaging method according to claim 17, wherein the preset difference value is a value close to 0.

20. A non-transitory computer-readable storage medium having a computer program stored thereon, wherein the computer program, when executed by a processor, implements the imaging method according to claim 16.
